(19) United States
(12) Patent Application Publication
(10) Pub. No.: US 2007/0154151 A1
(43) Pub. Date: Jul. 5, 2007

(54) Laser module and method of making

(76) Inventors: Tony K. T. Chen, Dasi Township (TW); Yi-Lung Weng, Keelung (TW); Der-Shyang Jan, Taipei (TW); Teng-Yuan Chien, Keelung (TW)

Correspondence Address: Raymond Sun, 12420 Woodhall Way, Tustin, CA, 92782, US

(21) Appl. No.: 11/633,391

(22) Filed: Dec. 4, 2006

(30) Foreign Application Priority Data
Jan. 3, 2006 (TW) 95100125

(51) Int. Cl. G02B 6/36

(52) U.S. Cl. 385/92

(57) ABSTRACT

A laser module has a housing and a laser light source. The housing is made of a material that is pervious to light and has a first end that is provided with a lens, and a second end that is provided with an opening extending into the housing to a location adjacent to the lens. The laser light source is secured in the opening at a location that is at a predetermined distance from the lens.

### BACKGROUND OF THE INVENTION

1. Field of the Invention

The present invention relates to a laser module, and in particular, to a low-cost laser module that is simple in construction, and which can be manufactured in a simple manner and at low cost.

2. Description of the Prior Art

Since laser possesses the characteristics of straightness, phase angle, and wavelength, it has been widely used as in devices that assist people in a number of different applications where it is important to delineate a straight line, such as laser pointers, laser sights, laser range finders, laser levelers, and so on. In such devices, a laser module comprising a laser diode and a focusing lens is used as a laser light source. Consequently, a laser module has become an indispensable assembly part for almost every laser device.

Conventional laser modules comprise a front housing disposed with a focusing lens and a rear housing disposed with a laser light source, such as a laser diode. The front and rear housings are provided with inner or outer screws to provide focusing adjustment of the laser light source relative to the focusing lens. Such a design not only requires a large number of parts but also requires a complicated assembling process. Consequently, attempts have been made to simplify the construction and assembly process for laser modules. U.S. Pat. No. 5,905,751 illustrates one example of a simplified method and structure for a laser module. However, the connection mechanism used in the laser module for U.S. Pat. No. 5,905,751 does not adequately simplify the manufacturing process and cost, and the materials that can be used for its housing are limited. Therefore, there is still a need for a laser module which can not only be built from a wider selection of materials, but can also simplify the structure and reduce manufacturing cost.

### SUMMARY OF THE DISCLOSURE

It is an object of the present invention to provide a laser module having a simplified construction, and which can be assembled conveniently and at low cost.

In order to accomplish the objects of the present invention, there is provided a laser module having a housing and a laser light source, where the housing is made of a material that is pervious to light and having a first end that is provided with a lens, and a second end that is provided with an opening extending into the housing to a location adjacent to the lens. The laser light source is secured in the opening at a location that is at a predetermined distance from the lens.

The present invention also provides a method of making a laser module. The method provides a housing having a first end provided with a lens, and a second end provided with an opening extending into the housing to adjacent the lens. The method then includes the step of pushing a laser light source with a base into the opening from the second end to focus the emitted light between the laser light source and the lens. Next, light from an external light source is caused to penetrate the housing at the location of the base of the focused laser light source, thereby causing heat from the light to be absorbed by the base to secure the laser light source at a desired location in the opening

### BRIEF DESCRIPTION OF THE DRAWINGS

FIG. 1 is a schematic diagram of a laser module in accordance with a first embodiment of the present invention.

FIG. 2 is a schematic diagram of a laser module in accordance with a second embodiment of the present invention.

FIG. 3 is a schematic diagram of a laser module in accordance with a third embodiment of the present invention.

FIG. 4 is a perspective view of the housing of a laser module in accordance with one preferred embodiment of the present invention.

FIG. 5 is a cross-sectional view of the laser module in FIG. 4.

FIG. 6 is a perspective view of the housing of another laser module in accordance with another preferred embodiment of the present invention.

FIG. 7 is a cross-sectional view of the laser module in FIG. 6.

FIG. 8 is a perspective view of the housing of yet another laser module in accordance with yet another preferred embodiment of the present invention.

FIG. 9 is a cross-sectional view of the laser module in FIG. 8.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

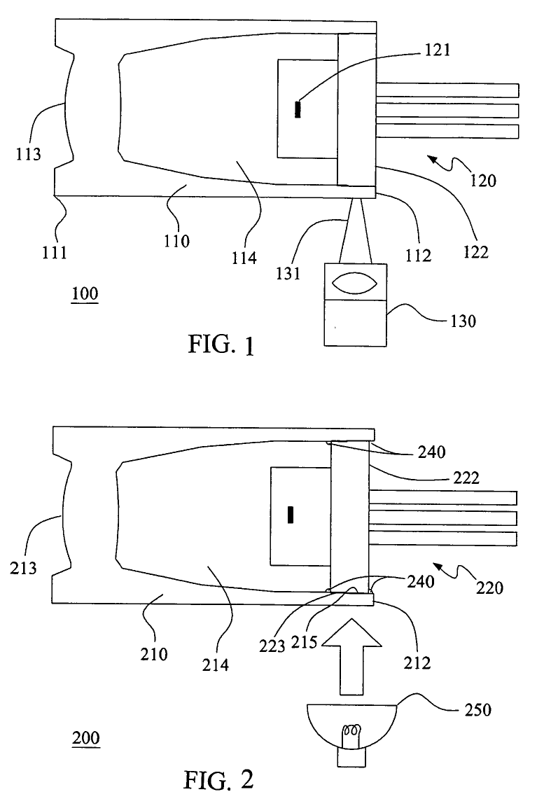

FIG. 1 illustrates a first embodiment of a laser module 100 and its manufacturing method according to the present invention. The laser module 100 has a housing 110 and a laser light source 120. The housing 110 can be a cylindrical housing with a first end 111 and a second end 112. A convex lens 113 is provided at the first end 111 to collimate the laser beam generated by the laser light source 120 so as to produce approximately parallel laser beams. The second end 112 has an opening 114 extending into the housing 110 and to a location adjacent the convex lens 113. The opening 114 is intended to accommodate the laser light source 120. The laser light source 120 includes a laser diode 121 and a base 122 for securing the laser diode 121. The base 122 has at least part of its contour compatible with the shape of the opening 114 so as to secure the laser light source 120 in the opening 114 at a location which is at a certain distance (usually the focal length of the convex lens 113) away from the convex lens 113.

When the laser module 100 is being assembled, the laser light source 120 is pushed into the opening 114 from the second end 112 of the housing 110. When the laser light source 120 is being moved forward, focusing of the light source 120 is carried out by observing the size of the projected light spot (from light source 120) on a target from the laser beam generated by the laser module 100. When the focusing has been completed, a laser beam 131 that is generated by an external light source 130 is focused on the area adjoining the housing 110 and the base 122 of the laser light source 120. The high energy-density laser beam 131 generated by the external light source 130 will penetrate the housing 110 and reach the base 122 to produce heat, thereby causing the area adjoining the housing 110 and the base 122 of the laser light source 120 to be melted by the heat such that laser light source 120 may be secured at the desired location in the opening 114.

For the laser beam 131 generated by the external light source 130 to be able to penetrate the housing 110 and reach the base 122 of the laser light source 120, the housing 110 should be made of a material that is pervious to light; for example, plastics or glass. The housing 110 and the convex lens 113 may be two separate elements that are combined together, or are separate parts that are integrally formed by injection molding, so as to further simplify the number of parts for the laser module 100. Furthermore, there is no other requirement for the base 122 of the laser light source 120, other than that it has to be a material that can absorb light so as to transfer the energy of the laser beam 131 into heat energy. Thus, in one embodiment of the present invention, a plastic base 122 may be used to reduce the cost of making the laser module 100.

FIG. 2 illustrates a second embodiment of a laser module 200 and its manufacturing method according to the present invention. The laser module 200 may also include a housing 210 and a laser light source 220, and the housing 210 and the laser light source 220 may also have the same construction as the housing 110 and the laser light source 120 shown in FIG. 1. The differences between the embodiments in FIG. 1 and FIG. 2 lie in that, before the laser light source 220 is pushed into the opening 214 from the second end 212, the inner wall 215 of the housing 210 or the outer surface 223 of the base 222 is first coated with a layer of photo-hardened-resin 240 such that, when the focusing of the laser light source 220 with respect to the convex lens 213 is completed, the photo-hardened-resin 240 may be hardened by projecting, for example, ultraviolet light from an ultraviolet light source 250 to secure the laser light source 220 at the desired location in the opening 214.

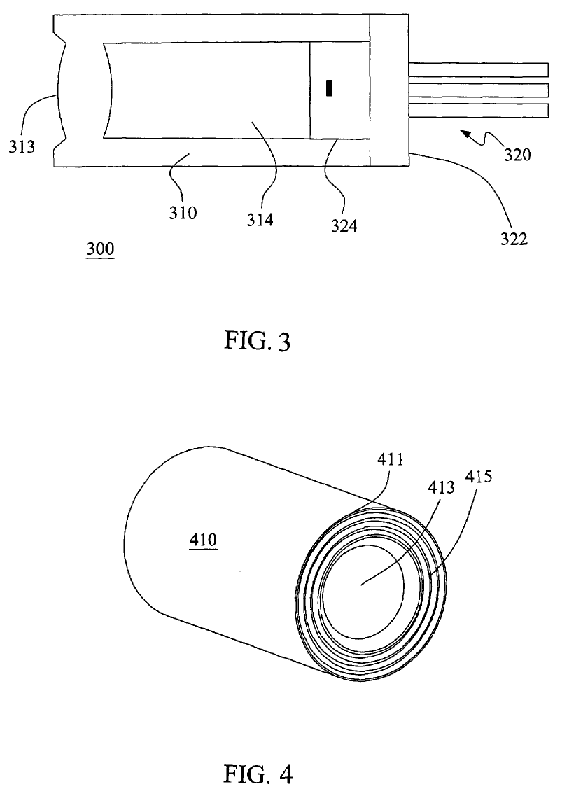

FIG. 3 illustrates a third embodiment of a laser module 300 and its manufacturing method according to the present invention. The laser module 300 may also include a housing 310 and a laser light source 320 that are similar in construction to the housings 110, 210 and light sources 120, 220 (and their methods of manufacture) shown in FIG. 1 or FIG. 2. The differences between the embodiment of FIG. 3 and the embodiments of FIGS. 1 and 2 lie in that the size (e.g., the diameter or dimension) and shape of the opening 314 of the housing 310 correspond to the size and shape of the cap 324 on the base 322 of the laser light source 320, such that the cap 324 of the laser light source 320 can be snugly secured on the focal point relative to the convex lens 313 by merely pushing the cap 324 into the housing 310 to be connected with the housing 310. As a result, the opening 314 can be smaller than the openings 114 and 214 in FIGS. 1 and 2 to further reduce the manufacturing cost of the housing 310.

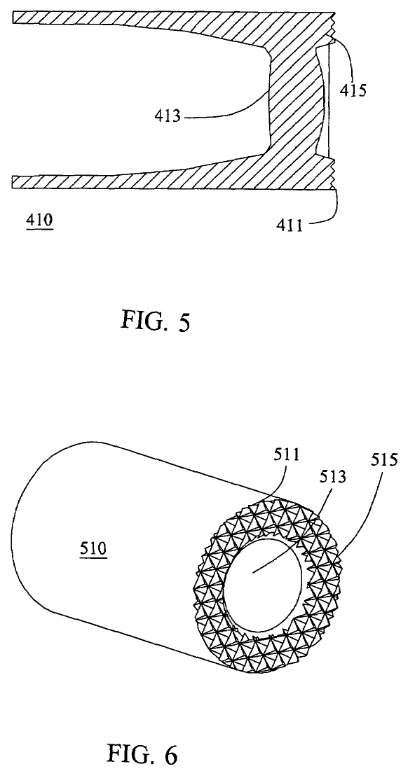

FIGS. 4 to 9 provide perspective and cross-sectional views of the preferred embodiments of the laser module according to the present invention. Specifically, FIGS. 4-9 illustrate the different housings that can be used for the housinfs 110, 210 and 310. First, FIGS. 4 and 5 show the first end 411 of a housing 410, which is provided with a wavy pattern 415 that is positioned around the convex lens 413.

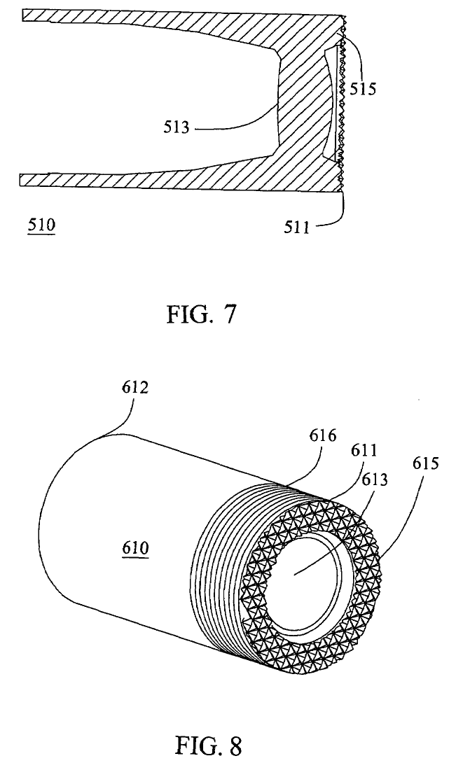

FIGS. 6 and 7 show the first end 511 of a housing 510, which is provided with a plurality of pointed bodies 515 that are positioned around the convex lens 513. These pointed bodies 515 define alternating ridges and valleys.

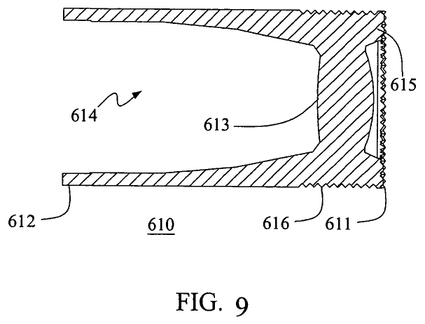

FIGS. 8 and 9 show the first end 611 of a housing 610, which is provided with a plurality of pointed bodies 615 (which can be the same as the pointed bodies 515) that are positioned around the convex lens 613. In addition, a plurality of annular grooves 616 can be provided on the external surface of the housing 610 between the first end 611 and the second end 612, but adjacent the first end 611, and positioned around the opening 614.

Since the housings 410, 510, and 610 shown in FIGS. 4-9 are made of a material that is pervious to light (such as plastics or glass), when the housings 410, 510, and 610 are used to replace the housings 110, 210, and 310 of the laser modules 100, 200, and 300 shown in FIGS. 1 to 3, respectively, the wavy pattern 415 surrounding the convex lens 413 may be used to reflect the laser light around the exterior of the convex lens 413. Similarly, the pointed bodies 515 surrounding the convex lens 513 may be used to reflect the laser light around the exterior of the convex lens 513. Finally, the pointed bodies 615 surrounding the convex lens 613 and the annular grooves 616 surrounding the opening 614 may at the same time be used to reflect the laser light around the exterior of the convex lens 613. Reflecting the laser light around the exterior of the respective convex lenses 413, 513 and 613 (which is known as “stray light”) will help to prevent the stray light from penetrating forward to affect the actual laser beam that is emitted from the convex lenses 413, 513 or 613, thereby improving the quality of parallel laser beam generated by the laser modules 100, 200, and 300 shown in FIGS. 1 to 3, respectively.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A laser module, comprising:
a housing made of the material that is pervious to light and having a first end provided with a lens and a second end provided with an opening extending into the housing to a location adjacent the lens; and
a light source secured in the opening at a location at a predetermined distance from the lens.

2. The laser module of claim 1, wherein the housing and the lens are integratedly formed.

3. The laser module of claim 1, wherein the housing is a cylindrical housing.

4. The laser module of claim 1, wherein the housing is made of plastic.

5. The laser module of claim 1, wherein the housing is made of glass.

6. The laser module of claim 1, wherein the first end of the housing is disposed with a wavy pattern surrounding the lens.

7. The laser module of claim 1, wherein the first end of the housing is disposed with a plurality of pointed bodies surrounding the lens.

8. The laser module of claim 7, wherein the area between the first end and the second end is disposed with a plurality of ring grooves surrounding the opening.

9. The laser module of claim 1, wherein the lens is a convex lens.

10. The laser module of claim 1, wherein the laser light source comprises:
a base having a contour compatible with the shape of the opening; and
a laser diode secured on the base.

11. The laser module of claim 10, wherein the base is made of plastic.

12. The laser module of claim 1, wherein the predetermined distance is the focal length of the lens.

13. A method of making a laser module, comprising:
providing a housing comprising a first end provided with a lens, and a second end provided with an opening extending into the housing to adjacent the lens;
pushing a laser light source with a base into the opening from the second end to focus the emitted light between the laser light source and the lens; and
causing light from an external light source to penetrate the housing at the location of the base of the focused laser light source, thereby causing heat from the light to be absorbed by the base to secure the laser light source at a desired location in the opening.

14. The method of claim 13, wherein the light source generates a laser beam.

15. The method of claim 13, further including the step of coating either the inner wall of the housing or the outer surface of the base with a layer of photo-hardened-resin.

16. The method of claim 15, wherein the light source generates ultraviolet light.

17. The method of claim 13, further including the step of forming the housing and the lens in an integral manner by injection molding.

18. A method of making a laser module, comprising:
providing a housing comprising a first end provided with a lens, and a second end provided with an opening extending into the housing to adjacent the lens; and
pushing a laser light source with a base into the opening from the second end to focus the emitted light between the laser light source and the lens;
wherein opening has a size and a shape that corresponds to the size and shape of the base such that the base is snugly secured at the opening by merely pushing the base into the opening.
